(19) United States
(12) Patent Application Publication
(10) Pub. No.: US 2017/0076255 A1
(43) Pub. Date: Mar. 16, 2017

(54) MEDICAL CARE SUPPORT SYSTEM, SERVER DEVICE AND COMPUTER READABLE STORAGE MEDIUM STORING PROGRAM

(71) Applicant: KONICA MINOLTA, INC., Tokyo (JP)

(72) Inventor: Youko KOUDA, Tokyo (JP)

(73) Assignee: KONICA MINOLTA, INC., Tokyo (JP)

(21) Appl. No.: 15/265,666

(22) Filed: Sep. 14, 2016

(30) Foreign Application Priority Data
Sep. 15, 2015 (JP) 2015-181313

(51) Int. Cl. G06Q 10/10; G06F 19/00

(52) U.S. Cl. CPC G06Q 10/1097; G06F 19/321

(57) ABSTRACT

A medical care support system includes: a server device including a storage unit, an information obtaining unit and an output control unit; and a portable home visit terminal. The storage unit stores patient information and image data. The information obtaining unit obtains home visit appointment information containing patient identification information to identify a home-visited patient, home visit appointment date and time for the patient, and examination appointment information at the home visit for the patient. The output control unit, based on the home visit appointment information, extracts patient information on the patient identified by the patient identification information and selectively extracts image data of the patient necessary for the home visit for the patient from the patient information and the image data stored in the storage unit, and outputs the extracted patient information and image data to the terminal.

### CROSS-REFERENCE TO RELATED APPLICATIONS

This application claims a priority under the Paris Convention of Japanese Patent Application No. 2015-181313 filed on Sep. 15, 2015, the entire disclosure of which, including the specification, claims, drawings and abstract, is incorporated herein by reference in its entirety.

### FIELD OF THE INVENTION

The present invention relates to a medical care support system, a server device and a computer readable storage medium storing a program.

### DESCRIPTION OF THE RELATED ART

Until recently, data, such as patient information, managed by a hospital server has been shared only between the hospital server and a hospital client terminal(s) connected with the hospital server for data communications. These days, in the field of medical service, demand for home medical care has been increasing, and there are requests to carry out patient information with portable terminals, such as laptop personal computers, at the time of home visits. However, in a hospital server, a large amount of patient information on all the patients including hospital-visiting patients is stored, and hence risk of data leakage, data loss or the like is high. Therefore, it is difficult and undesirable to carry out patient information on all the patients.

Then, there is described, for example, in Japanese Patent Application Publication No. 2005-100069 a technique of managing home visit destination information, patient information and home visit information being linked with one another, and, when a visited group constituted of patients who belong to a facility as a home visit destination is selected, extracting patient information on each of the patients who belong to the selected visited group and copying the same to a portable device. This makes it possible, for example, to extract patient information on each of patients who belong to a facility as a home visit destination only and copy the same to a portable device.

The technique described in Japanese Patent Application Publication No. 2005-100069 is a technique of extracting patient information on each of patients who belong to a selected visited group and copying the same to a portable device. However, it is not always necessary to carry out the entire patient information on each of visited patients. For example, image data contained in the patient information has a large file size and takes a lot of time to copy. Therefore, it is preferable to carry out necessary data only. Further, selecting a patient(s) and patient information thereon at the time of carrying out data is trouble and inefficient because, for example, even for confirmation of images necessary on the day, it is necessary to obtain information from other materials, such as health records, or to search one's memory.

### BRIEF SUMMARY OF THE INVENTION

The present invention has been conceived in view of the above circumstances, and objects of the present invention include providing a medical care support system, a server device and a computer readable storage medium storing a program each of which can efficiently perform copying work while reducing risk of data leakage, data loss or the like.

In order to achieve at least one of the objects, according to a first aspect of the present invention, there is provided a medical care support system including: a server device; and a portable home visit terminal, wherein the server device includes: a storage unit which stores patient information on a patient and image data of the patient; an information obtaining unit which obtains home visit appointment information containing patient identification information to identify a visited patient for whom a home visit is made, home visit appointment date and time for the visited patient, and examination appointment information at the home visit for the visited patient; and an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal, the home visit terminal is connected with the server device for data communication, and the home visit terminal, includes a receipt-storage unit which receives and stores the patient information and the image data sent from the server device.

According to a second aspect of the present invention, there is provided a server device which is connected with a portable home visit terminal for data communication, including: a storage unit which stores patient information on a patient and image data of the patient; an information obtaining unit which obtains home visit appointment information containing patient identification information to identify a visited patient for whom a home visit is made, home visit appointment date and time for the visited patient, and examination appointment information at the home visit for the visited patient; and an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal.

According to a third aspect of the present invention, there is provided a computer readable storage medium storing a program to cause a computer of a server device which is connected with a portable home visit terminal for data communication and includes a storage unit which stores patient information on a patient and image data of the patient, to function as: an information obtaining unit which obtains home visit appointment information containing patient identification information to identify a visited patient for whom a home visit is made, home visit appointment date and time for the visited patient, and examination appointment information at the home visit for the visited patient; and an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal.

### BRIEF DESCRIPTION OF THE SEVERAL VIEWS OF THE DRAWING

The present invention is fully understood from the detailed description given hereinafter and the accompanying drawings, which are given by way of illustration only and thus are not intended to limit the present invention, wherein:

FIG. 1 is a block diagram showing the main control configuration of each device constituting a medical care support system according to an embodiment of the present invention;

FIG. 2 shows an example of structures of various tables and an example of a correspondence between the tables;

FIG. 3 shows an example of classification of image files;

FIG. 4 shows an example of a receipt list screen;

FIG. 5 shows an example of a next home visit date setting screen;

FIG. 6 is a flowchart showing operation of the medical care support system according to the embodiment;

FIG. 7 shows an example of a home visit output screen;

FIG. 8 shows an example of a patient information screen; and

FIG. 9 is a flowchart showing operation of the medical care support system according to a third modification of the present invention.

### DETAILED DESCRIPTION OF THE INVENTION

Hereinafter, an embodiment of the present invention is detailed with reference to the drawings.

### [Configuration of Medical Care Support System]

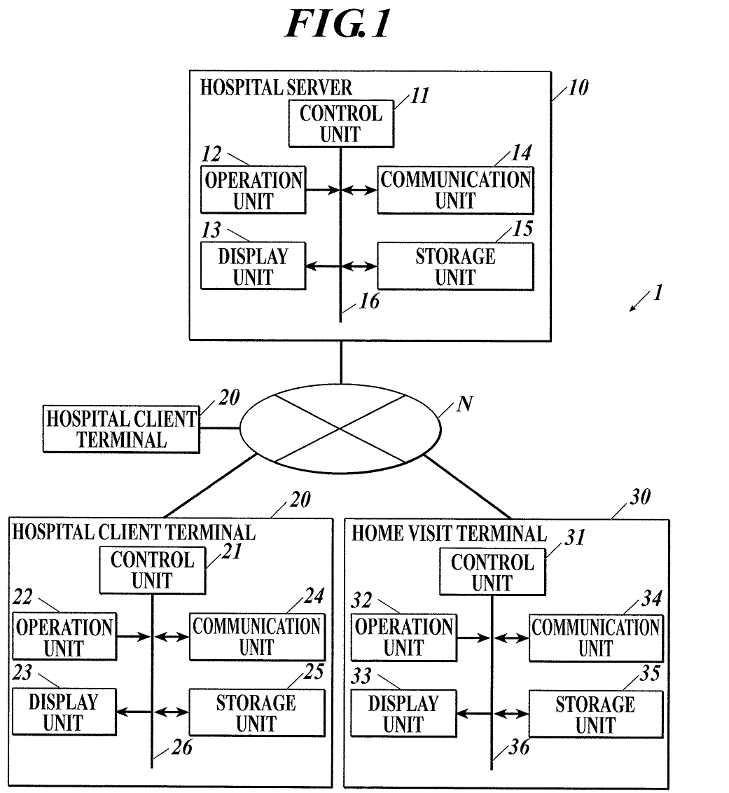

As shown in FIG. 1, a medical care support system 1 according to an embodiment of the present invention includes a hospital server (server device or data management server) 10, a hospital client terminal(s) (client terminal(s)) 20 and a home visit terminal (s) 30. These devices of the medical care support system 1 are connected with one another via a communications network N, such as LAN (Local Area Network), for data communications.

As a communication method used in a hospital, in general, DICOM (Digital Image and Communications in Medicine) standard is used, and for communications between the devices connected with one another via LAN, DICOM MWM (Modality Worklist Management) and DICOM MPPS (Modality Performed Procedure Step) are used. The communication method applicable to the embodiment is not limited to the above.

The hospital server 10 stores and manages patient information and medical data sent from the hospital client terminal 20, the home visit terminal 30 and so forth via the communications network N. The medical data is data relevant to medical service, and contains, for example, image data of medical images obtained by imaging with modalities (not shown), examination data and vital data. The hospital server 10 provides patient information and medical data (e.g., image data) in response to requests from external devices, such as the hospital client terminal 20 and the home visit terminal 30.

The hospital client terminal 20 is a computer device constituted of a PC or the like and having an electronic health record display function, an image viewer function and so forth. The hospital client terminal 20 displays electronic health records based on the patient information obtained from the hospital server 10. The hospital client terminal 20 also displays medical images based on the image data of the medical images obtained from the hospital server 10.

The home visit terminal 30 is a portable terminal device, such as a laptop PC or a tablet terminal. In the home visit terminal 30, software is installed so that copied information can be operated (used) in the same way as its corresponding information operated (used) in the hospital terminals (the hospital server 10 and the hospital client terminal 20). The home visit terminal 30 is usually connected with the hospital server 10 and the hospital client terminal 20 via the communications network N, but disconnected from the communications network N and carried by a doctor to home visit destinations at the time of home visits.

### [Configuration of Hospital Server]

As shown in FIG. 1, the hospital server 10 includes a control unit 11, an operation unit 12, a display unit 13, a communication unit 14 and a storage unit 15, and these units are connected with one another via a bus 16.

The control unit 11 includes a CPU, a ROM and a RAM and controls process operations of the units of the hospital server 10 as a whole. More specifically, the CPU reads various process programs stored in the ROM in response to operation signals input from the operation unit 12 or command signals received by the communication unit 14, opens the read programs on the RAM and performs various processes by working together with the programs.

The operation unit 12 includes: a keyboard including cursor keys, number input keys and various function keys; and a pointing device, such as a mouse. The operation unit 12 outputs, to the control unit 11, operation signals input by key operations on the keyboard or by mouse operations.

The display unit 13 includes a monitor, such as an LCD (Liquid Crystal Display), and displays various screens in response to commands of display signals input from the control unit 11.

The communication unit 14 includes a network interface and sends/receives data to/from the external devices connected thereto via the communications network N. For example, the communication unit 14 receives image data obtained by modalities imaging patients. The communication unit 14 also receives examination data and vital data obtained by various measurement devices.

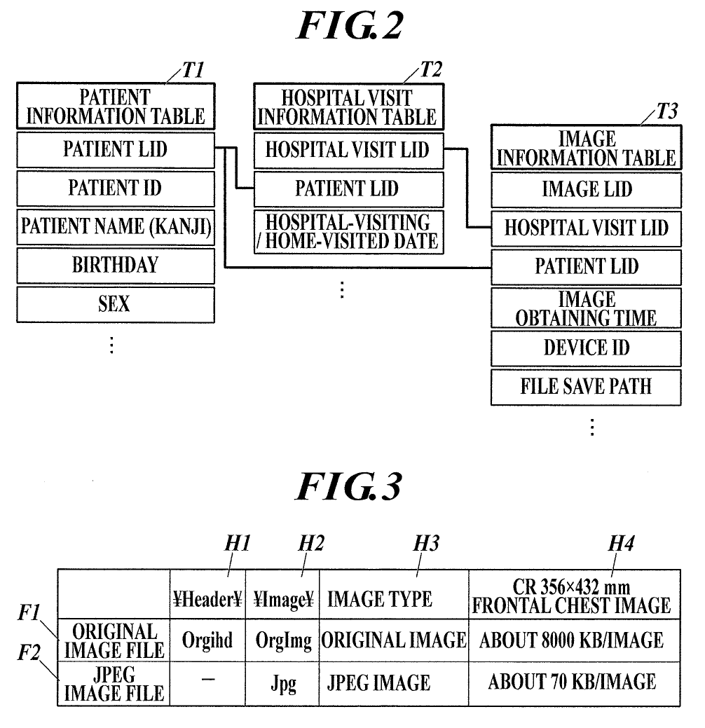

The storage unit 15 includes an HDD and/or a nonvolatile memory and stores, for example: various process programs; and parameters, files and so forth necessary for execution of the programs. The storage unit 15 also stores medical data. For example, the storage unit 15 stores examination data and vital data received by the communication unit 14. The storage unit 15 also stores, as shown in FIG. 2, a patient information table T1 to manage patient information on each patient, a hospital visit information table T2 to manage hospital visit information on each hospital visit, and an image information table T3 to manage image information on each image.

In the patient information table T1, for each patient LID (Link Identification), a patient ID for uniquely identifying a patient, a patient name (in kanji), a patient birthday, a patient sex and so forth are stored by being correlated with one another.

In the hospital visit information table T2, for each hospital visit LID, a patient LID, a patient hospital-visiting/home-visited date and so forth are stored by being correlated with one another. The patient LID in the hospital visit information table T2 is linked with the patient LID in the patient information table T1 to indicate to which patient each hospital visit belongs.

In the image information table T3, for each image LID, a hospital visit LID, a patient LID, image obtaining time, a device ID for uniquely identifying a modality with which an image was obtained, a file save path indicating a place where an image file is saved and so forth are stored by being correlated with one another. The hospital visit LID in the image information table T3 is linked with the hospital visit LID in the hospital visit information table T2 to indicate to which hospital visit each image belongs. The patient LID in the image information table T3 is linked with the patient LID in the patient information table T1 to indicate to which patient each image belongs.

The image files stored in the storage unit 15 are classified into two types. More specifically, the image files are classified into an original image file F1 and a JPEG image file F2. As shown in FIG. 3, each image file is constituted of a header region (¥Header¥) H1 which stores a header file to be added to the top of image data and an image region (¥Image¥) H2 which stores the image data. In FIG. 3, the image type H3 is an item indicating a type of image data, and the CR 356×432 mm frontal chest image file size H4 is an item indicating a file size of a CR 356×432 mm frontal chest image for each image type.

The original image file F1 is constituted of the image region H2 which stores original image data (OrgImg) and the header region H1 which stores a header file (Orgihd) for the original image data. The file size of CR 356×432 mm frontal chest images (original images) in the original image file F1 is “about 8,000 KB/image”.

The JPEG image file F2 is constituted of the image region H2 which stores JPEG image data (Jpg). The file size of CR 356×432 mm frontal chest images (JPEG images) in the JPEG image file F2 is “about 70 KB/image”.

In the embodiment, if copying JPEG images is set, the JPEG image file F2 is copied, whereas if copying RAW images is set, the original image file F1 is copied.

### [Configuration of Hospital Client Terminal]

As shown in FIG. 1, the hospital client terminal 20 includes a control unit 21, an operation unit 22, a display unit 23, a communication unit 24 and a storage unit 25, and these units are connected with one another via a bus 26.

The control unit 21 includes a CPU, a ROM and a RAM and controls process operations of the units of the hospital client terminal 20 as a whole More specifically, the CPU reads various process programs stored in the ROM in response to operation signals input from the operation unit 22 or command signals received by the communication unit 24, opens the read programs on the RAM and performs various processes by working together with the programs.

The operation unit 22 includes: a keyboard including cursor keys, number input keys and various function keys; and a pointing device, such as a mouse. The operation unit 22 outputs, to the control unit 21, operation signals input by key operations on the keyboard or by mouse operations.

The display unit 23 includes a monitor, such as an LCD (Liquid Crystal Display), and displays various screens in response to commands of display signals input from the control unit 21. For example, the display unit 23 displays electronic health records, medical images and so forth.

The communication unit 24 includes a network interface and sends/receives data to/from the external devices connected thereto via the communications network N. For example, the communication unit 24 receives patient information from the hospital server 10. The communication unit 24 also receives image data of medical images from the hospital server 10.

The storage unit 25 includes an HDD and/or a nonvolatile memory and stores, for example: various process programs; and parameters, files and so forth necessary for execution of the programs.

### [Configuration of Home Visit Terminal]

As shown in FIG. 1, the home visit terminal 30 includes a control unit 31, an operation unit 32, a display unit 33, a communication unit 34 and a storage unit 35, and these units are connected with one another via a bus 36.

The control, unit 31 includes a CPU, a ROM and a RAM and controls process operations of the units of the home visit terminal 30 as a whole. More specifically, the CPU reads various process programs stored in the ROM in response to operation signals input from the operation unit 32 or command signals received by the communication unit 34, opens the read programs on the RAM and performs various processes by working together with the programs.

The operation unit 32 includes: a keyboard including cursor keys, number input keys and various function keys; and a pointing device, such as a mouse. The operation unit 32 outputs, to the control unit 31, operation signals input by key operations on the keyboard or by mouse operations. The operation unit 32 may be a touch panel integrated with the display unit 33, for example.

The display unit 33 includes a monitor, such as an LCD (Liquid Crystal Display), and displays various screens in response to commands of display signals input from the control unit 31.

The communication unit 34 includes a network interface and sends/receives data to/from the external devices connected thereto via the communications network N. For example, the communication unit 34 receives patient information and medical data (e.g., image data) from the hospital server 10.

The storage unit (receipt-storage unit) 35 includes an HDD and/or a nonvolatile memory and stores, for example: various process programs; and parameters, files and so forth necessary for execution of the programs. The storage unit 35 also stores patient information and medical data (e.g., image data) sent from the hospital server 10.

### [Operation of Medical Care Support System]

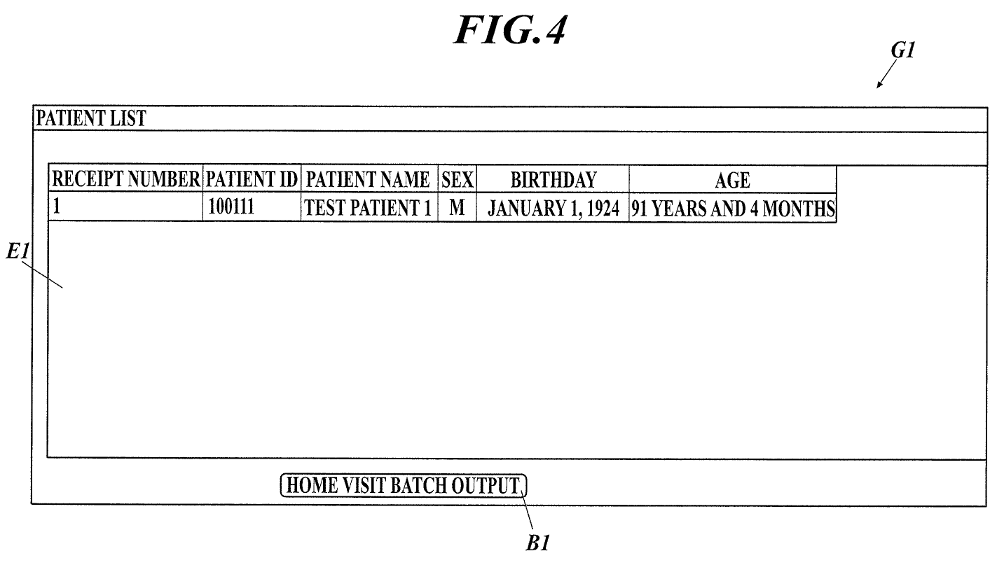

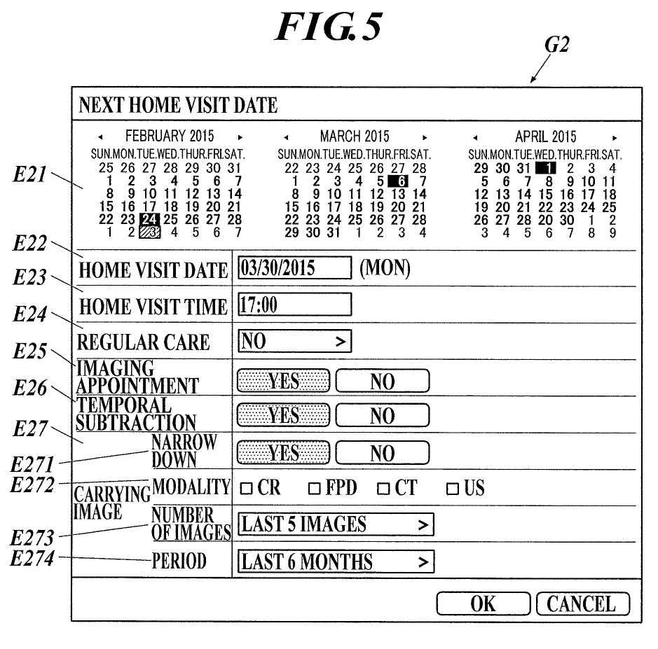

Next, operation of the hospital server 10 and the hospital client terminal 20 of the medical care support system 1 according to the embodiment is described in detail with reference to FIGS. 4 to 7. This operation is started by a receipt list screen G1 being displayed on the display unit 23 of the hospital client terminal 20 serving as a trigger.

As shown in FIG. 4, the receipt list screen G1 is a screen to display a list of patients who have gone through a reception counter each correlated with simple patient information (the patient ID, patient name, sex, birthday, age, etc.). In the receipt list screen G1, there is provided a received patient list display region E1 to display the list of patients who have gone through the reception counter. At the lower part of the receipt list screen G1, there is provided a home visit batch output button B1 to output patient information on and image files (image data necessary for home visits) of respective patients for whom home visits are scheduled on the day.

In a next home visit date setting screen G2 displayed on the display unit 33 of the home visit terminal 30, for a patient, the next home visit date and time (“Home Visit Date” and “Home Visit Time” in FIG. 5), images to be carried out at the time of the next home visit (“Carrying Image” in FIG. 5, hereinafter called “the next time carrying images”) and so forth are set in advance (in the embodiment, at the time of the last home visit), The next home visit date setting screen G2 is automatically displayed, for example, by an end operation to end a viewer screen (not shown) serving as a trigger. The viewer screen is a screen to display images taken at the last home visit, past images or the like.

As shown in FIG. 5, the next home visit date setting screen G2 is constituted of: a calendar display section E21 to display a calendar of the last month, this month and the next month; a home visit date input section E22 (“Home Visit Date”) to input the next home visit date; a home visit time input section E23 (“Home Visit Time”) to input the next home visit time; a home visit interval selection section E24 (“Regular Care”) to select a home visit interval if home visits are regularly made; an imaging appointment selection section E25 (“Imaging Appointment”) to select whether to perform imaging (CR/DR imaging) at the next home visit; a temporal subtraction selection section E26 (“Temporal Subtraction”) to select whether to perform temporal subtraction at the next home visit; and a carrying image setting section E27 (“Carrying Image”) to set the next time carrying images. The carrying image setting section E27 is constituted of: a carrying image narrowing-down setting section E271 (“Narrow Down”) to select whether to narrow down the next time carrying images; a carrying image modality setting section E272 (“Modality”) to select whether to narrow down the next time carrying images by modality with which carrying images were taken; a carrying image number setting section E273 (“Number of Images”) to set the number of the next time carrying images; and a carrying image period setting section E274 (“Period”) to narrow down the next time carrying images by period in which carrying images were taken.

By predetermined operations in the next home visit date setting screen G2, home visit appointment information can be set. The home visit appointment information contains: the next home visit date and time; examination appointment information, such as an imaging appointment at the next home visit and a temporal subtraction appointment at the next home visit; the next time carrying images; and so forth. That is, the control unit 31 of the home visit terminal 30 functions as a first information setting unit of the present invention. After the home visit appointment information, such as the next home visit date and time and the next time carrying images, is set in the next home visit date setting screen G2, the home visit terminal 30 is connected to the communications network N to send, with the communication unit 34, the home visit appointment information to the hospital server 10, thereby merging (storing) the above settings into the database of the hospital system 1 (hospital server 10), namely, updating the database thereof with the above settings. That is, the communication unit 34 of the home visit terminal 30 functions as a first information sending unit of the present invention.

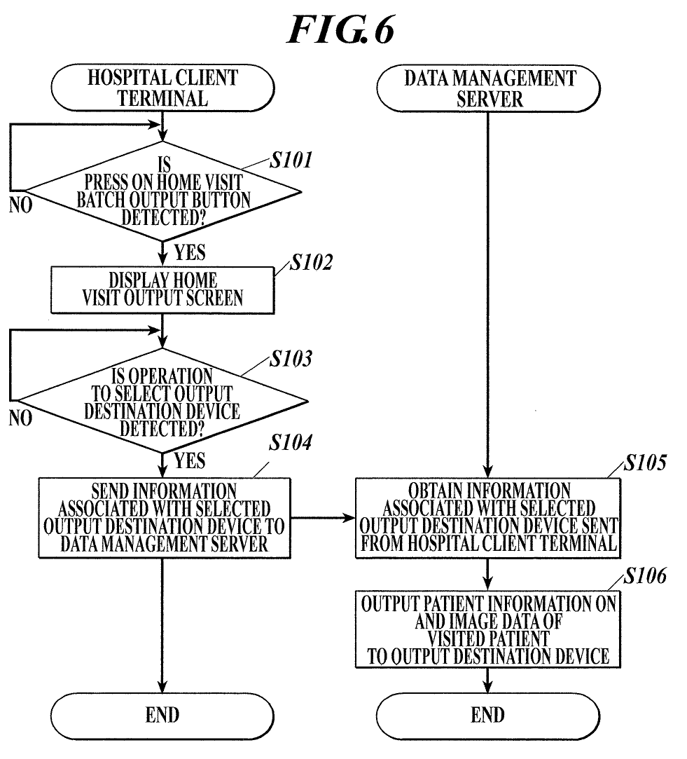

Hereinafter, operation performed when the home visit batch output button B1 in the receipt list screen G1 is pressed is described with reference to a flowchart shown in FIG. 6.

First, the control unit 21 of the hospital client terminal 20 determines whether a press operation on the home visit batch output button B1 displayed at the lower part of the receipt list screen. G is detected (Step S101).

When determines that a press operation on the home visit batch output button E1 is detected (Step S101; YES), the control unit 21 moves to Step S102.

On the other hand, when determines that no press operation on the home visit batch output button B1 is detected (Step S101; NO), the control unit 21 repeats Step S101 until a press operation on the home visit batch output button. 1 is detected.

Next, the control unit 21 causes the display unit 23 to display a home visit output screen G3 (Step S102).

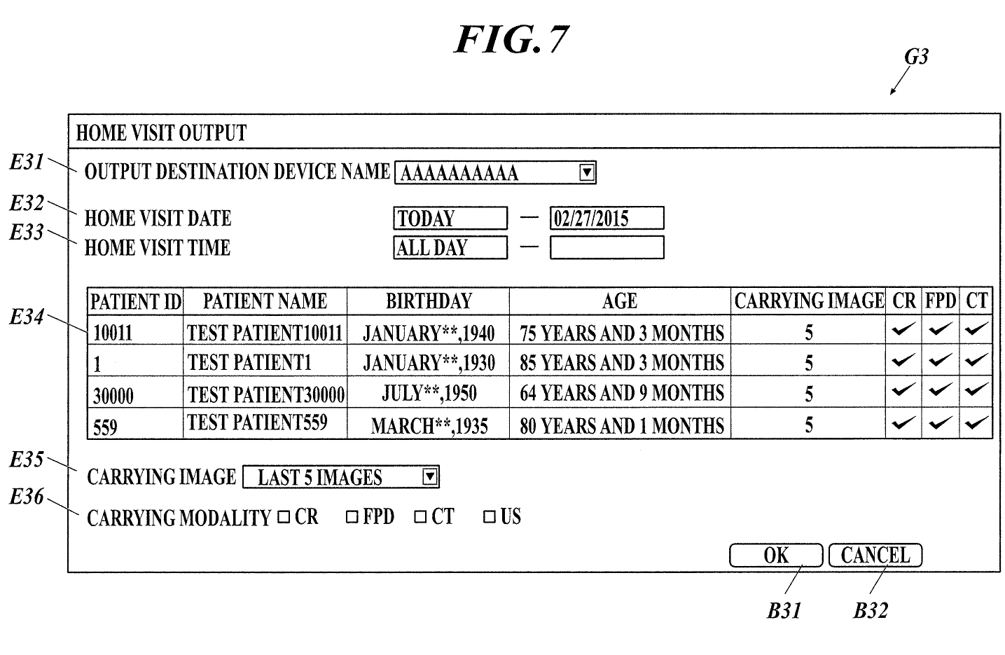

As shown in FIG. 7, the home visit output screen G3 is constituted of: an output destination device name selection section E31 (“Output Destination Device Name,”) to select a home visit terminal 30 as an output destination to which data (patient information and image file(s)) is output; a home visit date setting section E32 (“Home Visit Date”) to set a home visit date(s) to narrow down patients for whom home visits are made (hereinafter called “visited patients”) as data output targets by home visit date; a home visit time setting section E33 (“Home Visit Time”) to set home visit time(s) to narrow down visited patients as data output targets by home visit time; a list display section E34 to display a list of data to be output of respective visited patients as data output targets to whom visited patients have been narrowed down using the home visit date setting section E32 and the home visit time setting section E33; a carrying image number setting section E35 (“Carrying Image”) to set the number of carrying images for a visited patient selected from among the visited patients shown in the list displayed in the list display section E34; a carrying image modality setting section E36 (“Modality”) to narrow down carrying images for a visited patient selected from among the visited patients shown in the list displayed in the list display section E34 by modality with which carrying images were taken; and so forth.

In the list display section E34, a list is displayed. In the list, for each visited patient as a data output target, “Patient ID” information, “Patient Name” information, “Birthday” information and “Age” information which are patient information, “Carrying Image” information indicating the number of carrying images, and “CR” information, “FPD” information and “CT” information each indicating whether a carrying image(s) was taken with the modality are correlated. In the item of each of the “CR”, “FPD” and “CT”, if the modality is the one with which a carrying image(s) was taken, a check mark is displayed.

At the lower part of the home visit output screen G3, there are provided: an OK button B31 to output patient information on and image file(s) of patient(s) for whom home visit(s) are scheduled on the day; and a cancel button B32 to end the home visit output screen G3 and return to the previous screen.

In the embodiment, because the next home visit date and time, the next time carrying images and so forth are set in the next home visit date setting screen G2 in advance, these settings are reflected on the home visit output screen G3. That is, the control unit 21 (i) extracts visited patient(s) who are data output target (s) and patient information on and image data (image file(s)) of the data output target(s) and (ii) reflects them on the home visit output screen G3 at the timing of causing the display unit 23 to display the home visit output screen G3 at Step S102.

The home visit output screen G3 is a screen to perform change operations when it is desired to change the reflected settings. For example, by changing the settings of the home visit date setting section E32 and the home visit time setting section E33, the visited patients as data output targets can be changed, and by changing the settings of the carrying image number setting section E35 and the carrying image modality setting section E36 for a selected visited patient, the image file of the selected visited patient to be output can be changed. If no change operations are performed in the home visit output screen G3, the patient information and the image file(s) according to the reflected settings are output.

Next, the control unit 21 determines whether an output destination device selection operation to select an output destination device is detected (Step S103). More specifically, the control unit 21 determines whether a press operation on the OK button B31 provided at the lower part of the home visit output screen G3 displayed at Step S102 is detected, and when determines that a press operation on the OK button B31 is detected, determines that an output destination device selection operation is detected.

When determines that an output destination device selection operation is detected (Step S103; YES), the control unit 21 moves to Step S104.

On the other hand, when determines that no output destination device selection operation is detected (Step S103; NO), the control unit 21 repeats Step S103 until an output destination device selection operation is detected.

Next, the control unit 21 sends information associated with the output destination device selected (selected information) at Step S103 to the hospital server 10 via the communication unit 24 (Step S104). The selected information is home visit appointment information containing: information on the output destination device selected in the home visit output screen G3 (terminal identification information to identify a home visit terminal as an output destination); patient identification information to identify each visited patient; home visit appointment date and time and image data (carrying images) necessary for the home visit for each visited patient reflected on the home visit output screen G3 (or changed in the home visit output screen G3); examination appointment information; and so forth.

The control unit 11 of the hospital server 10 obtains the selected information (home visit appointment information) sent from the hospital client terminal 20 at Step S104 (Step S105) That is, the control unit 11 functions as an information obtaining unit of the present invention.

Next, the control unit 11, based on the selected information (home visit appointment information) obtained at Step S105, extracts patient information on each patient identified by the patient identification information from the patient information stored in the storage unit 15 and selectively extracts image data necessary for the home visit for each patient from the image data stored in the storage unit 15, and outputs the extracted patient information and image data to the output destination terminal (home visit terminal 30) identified by the terminal identification information (Step S106). That is, the control unit 11 functions as an output control unit of the present invention. The selected information (home visit appointment information) contains the information on carrying images. Hence, desired carrying images can be output instantly.

The home visit appointment information also contains information on an imaging appointment indicating whether to perform CR/DR imaging at the home visit for each visited patient. That is, if it is selected to perform CR/DR imaging in the imaging appointment selection section E25 of the next home visit date setting screen G2, information indicating that CR/DR imaging is performed is sent to the hospital server 10 as the imaging appointment information, and the hospital server 10 outputs, with respect to each visited patient considered, the image data containing the JPEG image file F2 of past images and the patient information to the home visit terminal 30. This makes it possible, when perform imaging at a home visit, to perform the same positioning as that of the last imaging by referring to the JPEG image file F2 of past images, and therefore makes it possible to easily compare taken images with the past images.

Past images are for positioning, and hence they do not need to be clear images. Therefore, the JPEG image file F2, which has a small file size, is output.

The home visit appointment information also contains information on a temporal subtraction appointment indicating whether to perform a temporal subtraction function at the home visit for each visited patient. That is, if it is selected to perform temporal subtraction in the temporal subtraction selection section E26 of the next home visit date setting screen G2, information indicating that the temporal subtraction function is performed is sent to the hospital server 10 as the temporal subtraction appointment information, and the hospital server 10 outputs, with respect to each visited patient considered, RAW images in the past, namely, the image data containing the original image file F1 of past images, and the patient information to the home visit terminal 30. This makes it possible to perform temporal subtraction at a home visit.

On the other hand, if it is selected not to perform temporal subtraction, the RAW images, which have a large file size, are unnecessary, and therefore past images are not output.

In the embodiment, after the home visit appointment information, such as the next home visit date and time and the next time carrying images, is set in the next home visit date setting screen G2, the home visit terminal 30 is connected to the communications network N to send the home visit appointment information to the hospital system 1 (hospital server 10). When determines that sending of the home visit appointment information ends, the control unit 31 of the home visit terminal 30 deletes the patient information and the image data stored in the storage unit 35. That is, the control unit 31 functions as a storage control unit of the present invention. Instead, the control unit 11 of the hospital server 10 may be made to function as the storage control unit.

As described above, according to the medical care support system 1 of the embodiment, the server device (hospital server 10) includes: the storage unit 15 which stores patient information on a patient(s) and image data of the patient(s); the image obtaining unit (control unit 11) which obtains home visit appointment information containing patient identification information to identify a visited patient for whom a home visit is made, home visit appointment date and time for the visited patient, and examination appointment information at the home visit for the visited patient; and the output control unit (control unit 11) which extracts, based on the home visit appointment information, patient information on the visited patient identified by the patient identification information from the patient information stored in the storage unit 15, selectively extracts, based on the home visit appointment information, image data of the visited patient necessary for the home visit for the visited patient from the image data stored in the storage unit 15, and outputs the extracted patient information and the extracted image data to the home visit terminal 30. The home visit terminal 30 includes the receipt-storage unit (storage unit 35) which receives and stores the patient information and the image data sent from the server device.

Consequently, the medical care support system 1 of the embodiment makes it possible to copy only the minimum required data to the home visit terminal 30, and therefore makes it possible to efficiently perform copying work while reducing risk of data leakage, data loss or the like.

Further, according to the medical care support system 1 of the embodiment, the home visit terminal 30 includes: the first information setting unit (control unit 31) which sets the home visit appointment information; and the first information sending unit (communication unit 34) which sends the home visit appointment information set by the first information setting unit to the server device, and the information obtaining unit obtains the home visit appointment information sent from the first information sending unit.

Consequently, the medical care support system 1 of the embodiment makes it possible to set the next home visit date and time and the next time carrying images and so forth in advance (at the time of the last home visit in the embodiment), and therefore makes it possible to save time and effort to select data at the time of carrying out data and also reduce errors in data selection.

Further, according to the medical care support system 1 of the embodiment, the home visit terminal 30 includes the storage control unit (control unit 31) which, after the first information sending unit sends the home visit appointment information set by the first information setting unit to the server device, deletes the patient information and the image data stored in the receipt-storage unit.

Consequently, the medical care support system 1 of the embodiment makes it possible to reduce leakage of data carried out with the home visit terminal 30, and therefore makes it possible to reduce risk of information leakage.

Further, according to the medical care support system 1 of the embodiment, the examination appointment information contains imaging appointment information indicating whether to perform CR/DR imaging at the home visit, and when the imaging appointment information indicates that CR/DR imaging is performed, the output control unit puts a past image(s) taken by CR/DR imaging in the image data to be output to the home visit terminal 30.

Consequently, the medical care support system 1 of the embodiment makes it possible to perform the same positioning as that of the last imaging when perform imaging at a home visit by referring to past images (JPEG image file F2), and therefore makes it possible to easily compare taken images with the past images.

Further, according to the medical care support system 1 of the embodiment, the examination appointment information contains temporal subtraction appointment information indicating whether to perform the temporal subtraction function at the home visit, and when the temporal subtraction appointment information indicates that the temporal subtraction function is performed, the output control unit puts a RAW file of a past image (s) in the image data to be output to the home visit terminal 30.

Consequently, the medical care support system 1 of the embodiment makes it possible to perform temporal subtraction at a home visit, and therefore makes it possible to increase accuracy of diagnosis at a home visit.

Further, according to the medical care support system 1 of the embodiment, the home visit appointment information contains terminal identification information to identify the home visit terminal 30 which is an output destination, and the output control unit outputs the patient information and the image data to the home visit terminal 30 identified by the terminal identification information.

Consequently, the medical care support system 1 of the embodiment makes it possible to output patient information and image data only to the home visit terminal 30 scheduled to be used for a home visit, and therefore makes it possible to prevent information leakage caused by, for example, copying data to another home visit terminal 30.

In the above, an embodiment of the present invention is described in detail. However, the present invention is not limited to the embodiment and hence can be appropriately modified without departing from the spirit of the present invention.

### [First Modification]

For example, in the embodiment, the next home visit date and time, the next time carrying images and so forth are set in the next home visit date setting screen G2 (FIG. 5) of the home visit terminal 30. However, this is not a limitation. For example, instead of setting the next home visit date and time, the next time carrying images and so forth in the next home visit date setting screen G2, these may be set in a next home visit date setting screen G2 called from a patient information screen G4 displayed on the hospital client terminal 20. The next home visit date setting screen G2 called from the patient information screen G4 of the hospital client terminal 20 has the same contents as the next home visit date setting screen G2 of the home visit terminal 30.

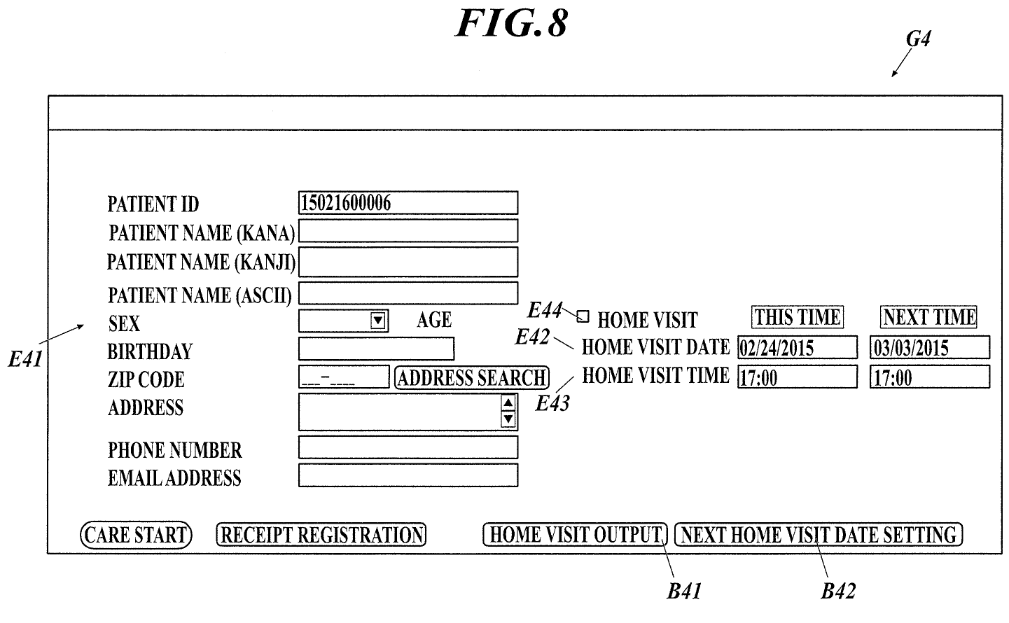

As shown in FIG. 8, the patient information screen G4 is constituted of: a patient information input section E41 to input various types of patient information; a home visit date input section E42 (“Home Visit Date”) to input the next home visit date; and a home visit time input section E43 (“Home Visit Time”) to input, the next home visit time.

At the upper left part of the home visit date input section E42, there is provided a visited patient indicating box section E44 (“□ Home Visit”) to indicate, by checking, that the displayed patient is a visited patient.

At the lower part of the patient information screen G4, there are provided: a home visit output button B41 to output patient information on and an image file of the displayed visited patient; and a next home visit date setting button B42 to display the next home visit date setting screen G2.

By a press operation on the next home visit date setting button B42 in the patient information screen G4, the next home visit date setting screen G2 is displayed, so that the home visit appointment information, such as the next home visit date and time and the next time carrying images, can be set. That is, the control unit 21 of the hospital client terminal 20 functions as a second information setting unit of the present invention. After the home visit appointment information, such as the next home visit date and time and the next time carrying images, is set from the patient information screen G4, the hospital client terminal 20 (control unit 21) sends, with the communication unit 24, the home visit appointment information to the hospital server 10, thereby merging (storing) the above settings into the database of the hospital system 1 (hospital server 10), namely, updating the database thereof with the above settings. That is, the communication unit 24 of the hospital client terminal 20 functions as a second information sending unit of the present invention.

As described above, according to the medical care support system 1 of the first modification, the client terminal (hospital client terminal 20) includes: the second information setting unit (control unit 21) which sets the home visit appointment information; and the second information sending unit (communication unit 24) which sends the home visit appointment information set by the second information setting unit to the server device, and the information obtaining unit obtains the home visit appointment information sent from the second information sending unit.

Consequently, the medical care support system 1 of the first modification makes it possible to set the next home visit date and time, the next time carrying images and so forth before copying data to the home visit terminal 30, and therefore makes it possible to save time and effort to select data at the time of carrying out data and also reduce errors in data selection.

Both the configuration to set the next home visit date and time, the next time carrying images and so forth in the next home visit date setting screen G2 of the home visit terminal 30 at the time of the last home visit and the configuration to set the next home visit date and time, the next time carrying images and so forth in the next home visit date setting screen. G2 called from the patient information screen G4 of the hospital client terminal 20 may be provided.

### [Second Modification]

Further, instead of setting the next home visit date and time, the next time carrying images and so forth in the next home visit date setting screen G2, a check box for each patient for whom a home visit should be made may be turned on in a patient list screen (not shown) where a list of all the patients registered in the medical care support system 1 is displayed. The patient list screen is displayed on the hospital client terminal 20.

Consequently, the medical care support system 1 of the second modification makes it possible to output patient information on and image data of a desired visited patient(s) to an output destination device, and therefore makes it possible, even if a visited patient needs to be added of a sudden immediately before data copying, to copy data of this visited patient too.

[Third. Modification]

Further, when the home visit output button B41 is pressed while the patient information screen G4 for a patient is being displayed, patient information on and image data of the patient may be output to an output destination device.

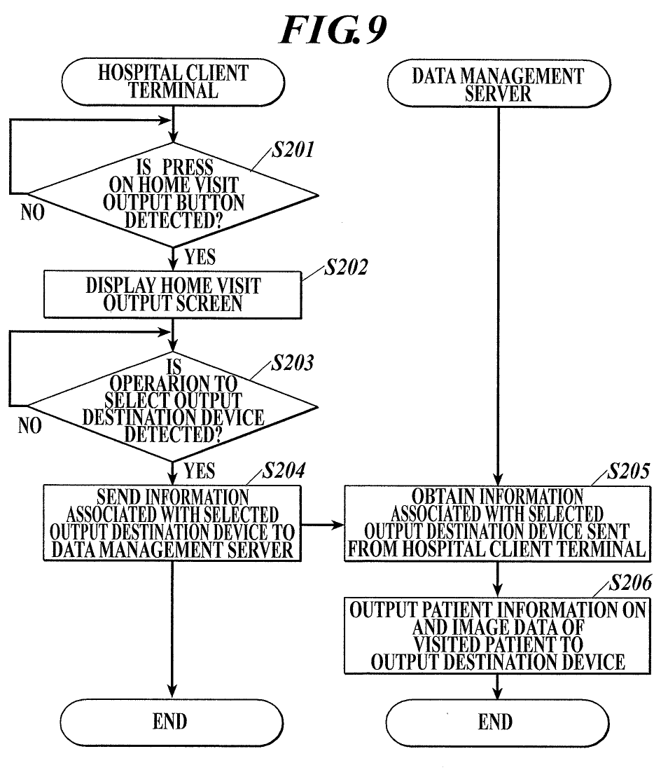

Hereinafter, operation performed when the home visit output button B41 in the patient information screen G4 is pressed is described with reference to a flowchart shown in FIG. 9.

First, the control unit 21 of the hospital client terminal 20 determines whether a press operation on the home visit output button B41 displayed at the lower part of the patient information screen G4 is detected (Step S201).

When determines that a press operation on the home visit output button B41 is detected (Step S201; YES), the control unit 21 moves to Step S202.

On the other hand, when determines that no press operation on the home visit output button B41 is detected (Step S201; NO), the control unit 21 repeats Step S201 until a press operation on the home visit output button B41 is detected.

Next, the control unit 21 causes the display unit 23 to display the home visit output screen G3 (Step S202). In the third modification, unlike the embodiment, the next home visit date and time, the next time carrying images and so forth are not set in advance. Hence, default settings are reflected on the home visit output screen G3.

Steps S203 to S205 are respectively the same as Steps S103 to S105 in FIG. 6, which shows operation of the medical care support system 1 of the embodiment, and therefore descriptions thereof are omitted here.

Next, the control unit 11, based on the information (containing the terminal identification information, etc.) associated with the selected output destination device (i.e., the selected information or home visit appointment information) obtained at Step S205, outputs the extracted patient information on and image data of the patient displayed in the patient information screen G4 to the output destination device (Step S206).

Consequently, the medical care support system 1 of the third modification makes it possible to easily output data of a single visited patient whose data has been forgotten to output.

### [Other Modifications]

In the embodiment, the patient information on and the image data of visited patients are output to an output destination device by a press on the home visit batch output button B1 serving as a trigger. However, this is not a limitation. For example, in the case where the home visit terminal 30 is connected to the communications network N, when preset time arrives, the patient information on and the image data of visited patients may be automatically output to an output destination device.

This makes it possible to perform copying work more efficiently without trouble.

Further, in the embodiment, at the time a user, such as a doctor, comes back to a hospital from a home visit, the home visit terminal 30 is connected to the communications network N to send the settings made in the next home visit date setting screen G2 to the hospital system 1 (hospital server 10), and deletes the patient information and the image data stored in the storage unit 35 of the home visit terminal 30. However, this is not a limitation. For example, a condition(s) may be set for deletion of the patient information and the image data. For example, the patient information and the image data stored in the storage unit 35 for a predetermined period or more only may be deleted therefrom. Alternatively or additionally, if more than a predetermined amount of patient information and image data is stored in the storage unit 35, the patient information and the image data may be deleted from the oldest to be the predetermined amount or less.

This makes it possible not to take the trouble to repeat data deletion and data copying in the case where data change is not essentially necessary because, for example, the next home visit is made shortly, and therefore makes it possible to avoid unnecessary work.

Alternatively or additionally, for example, the patient information and the image data to be used on the home visit appointment date (s) and time(s), which is contained in the home visit appointment information, being more than a preset period ahead from the current date and time only may be deleted from the storage unit 35.

Alternatively or additionally, for example, at the time a user, such as a doctor, comes back to a hospital from a home visit, only the above-described merging work into the hospital system 1 may be performed, and after the patient information and the image data are output to the home visit terminal 30 for the next home visit, the patient information and the image data unnecessary for the home visit only may be deleted from the storage unit 35.

This makes it possible to perform only the minimum required deletion work at the time of data copying, and therefore makes it possible to shorten work time for data transfer.

Further, in the embodiment, when CR/DR imaging is performed at a home visit, past images taken by CR/DR imaging are output to the home visit terminal 30. However, this is not a limitation. That is, even when CR/DR imaging is performed at a home visit, past images taken by CR/DR imaging may not be output to the home visit terminal 30.

Further, in the embodiment, when the temporal subtraction function is performed at a home visit, the RAW file of past images is output to the home visit terminal 30. However, this is not a limitation. That is, even when the temporal subtraction function is performed at a home visit, the RAW file of past images may not be output to the home visit terminal 30.

Further, in the embodiment, the patient information and the image data are output to the home visit terminal 30 identified by the terminal identification information. However, this is not a limitation. That is, the patient information and the image data may be automatically output to all the home visit terminals 30 on the communications network N.

Further, the embodiment and modifications in this application can be interpreted as those of a method, a program and the like. Under the method and program categories, the “units” or the like under the device category are interpreted as “steps”, “processes”, “means” and the like. In addition, the order of steps or processes is not limited to that specified in this application, and hence the order thereof may be changed, some steps/processes may be performed together, or each step/process may be performed portion by portion.

In addition to the above, detailed configurations and detailed operations of the devices or the like constituting the medical care support system can also be appropriately modified without departing from the spirit of the present invention.

What is claimed is:

1. A medical care support system comprising:
a server device; and
a portable home visit terminal, wherein
the server device includes:
a storage unit which stores patient information on a patient and image data of the patient;
an information obtaining unit which obtains home visit appointment information containing patient identification information to identify a visited patient for whom a home visit is made, home visit appointment date and time for the visited patient, and examination appointment information at the home visit for the visited patient; and
an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal,
the home visit terminal is connected with the server device for data communication, and
the home visit terminal includes a receipt-storage unit which receives and stores the patient information and the image data sent from the server device.

2. The medical care support system according to claim 1, wherein
the home visit terminal includes:
a first information setting unit which sets the home visit appointment information; and
a first information sending unit which sends the home visit appointment information set by the first information setting unit to the server device, and
the information obtaining unit obtains the home visit appointment information sent from the first information sending unit.

3. The medical care support system according to claim 2, wherein the home visit terminal includes a storage control unit which, after the first information sending unit sends the home visit appointment information set by the first information setting unit to the server device, deletes the patient information and the image data stored in the receipt-storage unit.

4. The medical care support system according to claim 3, wherein, after the first information sending unit sends the home visit appointment information set by the first information setting unit to the server device, the storage control unit deletes the patient information and the image data stored in the receipt-storage unit for a predetermined period or more.

5. The medical care support system according to claim 3, wherein, after the first information sending unit sends the home visit appointment information set by the first information setting unit to the server device, the storage control unit deletes the patient information and the image data stored in the receipt-storage unit from oldest until an amount of data stored in the receipt-storage unit becomes a predetermined amount or less.

6. The medical care support system according to claim 3, wherein, after the output control unit outputs the patient information and the image data to the home visit terminal, the storage control unit deletes the patient information and the image data which are stored in the receipt-storage unit but unnecessary for the home visit.

7. The medical care support system according to claim 1, further comprising a client terminal, wherein
the server device is connected with the client terminal for data communication,
the client terminal includes:
a second information setting unit which sets the home visit appointment information; and
a second information sending unit which sends the home visit appointment set by the second information setting unit to the server device, and
the information obtaining unit obtains the home visit appointment information sent from the second information sending unit.

8. The medical care support system according to claim 1, wherein
the examination appointment information contains imaging appointment information indicating whether to perform CR/DR imaging at the home visit, and
when the imaging appointment information indicates that CR/DR imaging is performed, the output control unit puts a past image taken by CR/DR imaging in the image data to be output to the home visit terminal.

9. The medical care support system according to claim 1, wherein
the examination appointment information contains temporal subtraction appointment information indicating whether to perform a temporal subtraction function at the home visit, and
when the temporal subtraction appointment information indicates that the temporal subtraction function is performed, the output control unit puts a RAW file of a past image in the image data to be output to the home visit terminal.

10. The medical care support system according to claim 1, wherein
the home visit appointment information contains terminal identification information to identify the home visit terminal which is an output destination, and
the output control unit outputs the patient information and the image data to the home visit terminal identified by the terminal identification information.

11. A server device which is connected with a portable home visit terminal for data communication, comprising:
a storage unit which stores patient information on a patient and image data of the patient;
an information obtaining unit which obtains home visit appointment information containing patient identification information to identify a visited patient for whom a home visit is made, home visit appointment date and time for the visited patient, and examination appointment information at the home visit for the visited patient; and
an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal.

12. A computer readable storage medium storing a program to cause a computer of a server device which is connected with a portable home visit terminal for data communication and includes a storage unit which stores patient information on a patient and image data of the patient, to function as:
an information obtaining unit which obtains home visit appointment information containing patient identification information to identify a visited patient for whom a home visit is made, home visit appointment date and time for the visited patient, and examination appointment information at the home visit for the visited patient; and
an output control unit which extracts, based on the home visit appointment information, patient information on the visited patient identified by the patient identification information from the patient information stored in the storage unit, selectively extracts, based on the home visit appointment information, image data of the visited patient necessary for the home visit for the visited patient from the image data stored in the storage unit, and outputs the extracted patient information and the extracted image data to the home visit terminal.
